(19) United States
(12) Patent Application Publication
(10) Pub. No.: US 2012/0182442 A1
(43) Pub. Date: Jul. 19, 2012

(54) HARDWARE GENERATION OF IMAGE DESCRIPTORS

(76) Inventor: Graham Kirsch, Bramley (GB)

(21) Appl. No.: 13/348,352

(22) Filed: Jan. 11, 2012

Related U.S. Application Data
(60) Provisional application No. 61/432,771, filed on Jan. 14, 2011.

(51) Int. Cl. G06K 9/62; H04N 5/228

(52) U.S. Cl. 348/222.1; 382/170; 348/E05.031

(57) ABSTRACT

Interest point and description circuitry is provided for tracking an object through multiple image frames. Interest point and description circuitry may be provided on an integrated circuit in an imaging device. Interest points and descriptors may be calculated at frame rate. A feature detection function may be applied to scaled images to extract interest points. Descriptors may be rotating circular gradient-histogram descriptors. Descriptors may have one or two rings, each having equal area. Descriptors may have discrete rotational positions and discrete scaling. Gradient-histograms may be calculated for the descriptors using angular, radial, and directional weighting components.

This application claims the benefit of provisional patent application No. 61/432,771, filed Jan. 14, 2011, which is hereby incorporated by reference herein in its entirety.

### BACKGROUND

This relates generally to image processing, and in particular, to hardware implementation of interest point detection processes.

An interest point is an accurately located, reproducible feature that can be extracted at the same position on an object from multiple images of the object. Images can vary in resolution, exposure, contrast, and color. Presentation of the object in the images can vary in displacement, rotations in plane, rotations out of plane, affine transform, and distance to the camera. Interest points should be ideally located at the same positions on the object across wide variations in all of these parameters.

The region surrounding an interest point is codified using a descriptor, centered on the interest point. A descriptor is a numerical representation of the image structure of a region that surrounds an interest point, often in the form of gradient frequency histograms.

Interest points and descriptors can be used to match small portions of video frames to each other. Interest points and descriptors can also be used for matching objects in still frames, or between still frames and video frames. Interest points and descriptors can be useful for such applications as tracking motion, 3D ranging, and object recognition.

Conventionally, interest point detection algorithms are optimized for fast computation with a computer processor. Conventional algorithms are often demanding of memory, using several image-sized sets of data for the fastest implementations. Substantial computing power is often need. Computation at frame rate is difficult.

It would be desirable to be able to provide interest point detection processing that can be implemented in hardware.

### BRIEF DESCRIPTION OF THE DRAWINGS

FIG. 1 is a diagram showing an illustrative imaging device having interest point and description circuitry in accordance with an embodiment of the present invention.

FIG. 2 is a flow chart showing steps for identifying interest points and constructing descriptors in accordance with an embodiment of the present invention.

FIG. 3A is diagram showing an illustrative descriptor having eight cells in accordance with an embodiment of the present invention.

FIG. 3B is diagram showing an illustrative descriptor having six cells in accordance with an embodiment of the present invention.

FIG. 4 is a diagram showing an illustrative hardware implementation for an imaging device having interest point and description circuitry in accordance with an embodiment of the present invention.

FIG. 5 is a diagram showing an illustrative hardware implementation for interest point and description circuitry in accordance with an embodiment of the present invention.

### DETAILED DESCRIPTION

Interest points are identifiable points in an image of an object that can be found in another image of the same object. The object may be presented with different position, rotation in the image plane, distance from the camera (and so size), rotation out of the image plane and lighting conditions. The interest point must be located in the same position with respect to the object in every image. Interest points are detected with mathematical functions that respond to features such as blobs and corners. Typically the maxima and minima of such functions, known as feature detection functions, indicate the position of an interest point.

Interest points may be combined with data records called descriptors that describe the structure of the area of the image surrounding the interest point. Interest points and descriptors are used for identifying and correlating related regions in two or more images.

An ideal interest point will always be accurately placed on an object regardless of the presentation of the object to the camera. To be useful, interest points must be able to be detected on an object when the object's position, rotation, and distance from the camera change. That is, the detection of points must be invariant to transformations in position, rotation, and scale. Ideally, any presentation of the object, including rotation out of the image plane should be allowed in the detection and description of the features (affine covariance). However, in practice this is harder, and requires iterative methods.

However, it is important that the properties of each interest point include its orientation and scale so that the presentation of the interest point can be eliminated when comparing interest points between images to find matches. The reported properties must be co-variant with the properties of the image.

The descriptor must also represent the presentation of the object to the camera. In this way the region surrounding the interest point can be transformed into a standard presentation, enabling comparisons between interest points in different images and corresponding regions detected in several frames.

Interest points are usually expensive to calculate, taking 50% or more of the processing resources of a desktop personal computer (PC) to calculate at video frame rates even for small images. Algorithms optimized for running in software on a desktop computer require a lot of memory—sometimes several frames—and are constrained to operate serially: one operation at a time.

Interest points are used in many applications that involve image understanding. Possible markets include anywhere it is necessary to identify objects. For example: 3-D imaging, object and person recognition, industrial inspection & control, automotive, motion tracking.

Having located an interest point, the next step would be to characterize the region of the image around it. This is done by building a data structure that describes the structure of the region surrounding the point, called a descriptor. The descriptor must be built in such a way that its size will vary with the size of the feature and its placement with respect to the object is aligned with the object in a reproducible way. When the object is presented differently in another image, the descriptor at the interest point will change its shape and size in the same way as the image of the object does.

When used with an interest point that has a scale and orientation associated with it, the descriptor is constructed with reference to the scale and orientation of the interest point. The orientation assigned to the interest point fixes the axes of the neighborhood of the interest point. The scale determines the size of the neighborhood. In this way, the descriptor should be independent of the size and orientation of the object on which the interest point has been detected: that is, it is scale and orientation invariant. In another image of the object, in which it may be smaller or larger and rotated, the descriptor around the same interest point will (ideally) be the same, allowing comparison with other descriptors from images at different scales and presentations.

Descriptors must be compared with one another in a way that is invariant with the properties of the captured image. To achieve this, points and descriptors must be normalized into a space where the differences due to rotation and scale are removed.

Generally, interest point detection algorithms are optimized for fast computation on a processor. They are mostly demanding of memory, using several image-sized sets of data for the fastest implementations. However, in a typical desktop computer, memory size is not a serious constraint. Generally, the implementation is constrained to use arithmetic precisions determined by the processor architecture: again, not apparently a serious constraint for a desktop computer. However, operation at frame rate is barely possible and requires substantial computing power with limits on image size and numbers of points detected.

It would be desirable to have a low cost, silicon-based implementation of interest point detection and description that will greatly reduce the system cost and increase the system performance of this functionality.

An implementation of an interest point detection and descriptor generation algorithm is provided that can be economically implemented on a single integrated circuit. The intention is to generate large numbers of interest points with associated descriptors from every frame streamed from a digital image sensor during transmission of the frame itself and to transmit it as part of the frame packet.

The economics of a dedicated, single-chip silicon implementation of a complex operation such as interest point detection are very different to a processor based approach. In silicon, memory is relatively very expensive. Even a single image frame of storage would be prohibitively expensive for large volume applications. Raster scan data flow and pipelined computation architectures make iterative algorithms hard and limit numbers of iterations possible. However, a very high degree of computational parallelism is possible. Also, arithmetic precision can be optimized and varied through the calculation.

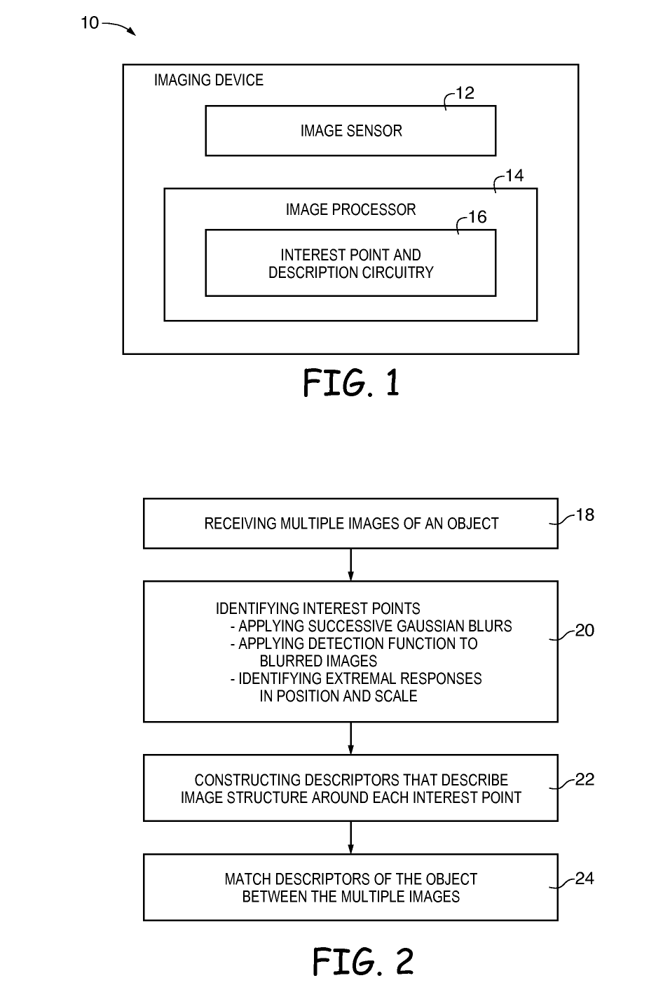

Interest point detection and description may be implemented in hardware. Circuitry for interest point detection and description may be implemented in an integrated circuit. In the example of FIG. 1, an imaging device 10 may be a digital camera, a cellular telephone having a digital camera, a webcam, a video camera, a handheld electronic device, or other suitable electronic device. Imaging device 10 may have an image sensor 12 and an image processor 14. Image sensor 12 may be a digital image sensor having an array of pixels. Image processor 14 may receive images from image sensor 12. Image processor 14 may be implemented on a single integrated circuit. If desired, image processor 14 may be implemented on multiple integrated circuits. Image processor 14 may have interest point and description circuitry 16. Interest point and description circuitry 16 may be hardwired on an integrated circuit.

An illustrative flow chart for identifying interest points and constructing descriptors is shown in FIG. 2. The steps of FIG. 2 may be performed by interest point and description circuitry 16 of FIG. 1. In step 18 of FIG. 2, multiple images of an object may be received by circuitry 16. Images may be received from an image sensor such as image sensor 12 of FIG. 1. The object may be differently scaled or rotated in each of the images. The images may be still images or individual frames of video. Interest point and descriptor extraction may be performed on grayscale images.

As shown in step 20 of FIG. 2, interest points may be identified using interest point and description circuitry 16 of FIG. 1. Successive Gaussian blurs may be applied to each image to produce multiple blurred images. Each of the multiple blurred images may be blurred to a different scale. The scale may be indicated by a deviation σ of the Gaussian. A doubling of scale may be known as an octave. Scale increments that are less than an octave may be known as sub-octave scales. A first image for each octave may be known as a base image for that octave, or octave base image.

A detection function may be applied to each of the blurred images that is responsive to features that are on the scale of the blurring. Interest points may be represented by external responses in the detection function. Interest points may have associated positions and orientation. An orientation of an interest point may be determined by a gradient of image structure at the interest point. Interest points may be extracted from images that are blurred at sub-octave scaling.

To detect features on an object at multiple scales the feature detection function must have properties that are invariant with respect to the size of the object. Part of the feature detection function is the transformation function applied to the image to change the scale of features detected in the image: the scaling function. The scaling function must have the property that it is the same shape no matter what the scale. The choice for this purpose is the Gaussian function, which is the same shape for all values of the deviation σ. (The constant shape is easily seen if the x axis is scaled as x/σ. As σ is varied, the shape does not change.)

$$G ( x , y , σ ) = \frac{1}{2 π {σ}^{2}} {e}^{- \frac{{x}^{2} + {y}^{2}}{2 {σ}^{2}}}$$

Applying a Gaussian blur filter to the image by convolving the image with the 2D Gaussian function effectively removes features that are smaller than the deviation σ of the Gaussian. The first and second derivatives of the image luma will now be greatest around the smallest remaining features—that is those of about the same size as the deviation σ.

Therefore, a three dimensional space may be constructed in which the x and y positions of the pixels is joined by a third scale dimension represented by the deviation σ of the Gaussian blur of the image. The deviation of the Gaussian may be known as the scale, σ.

Gaussian scale space has some convenient properties. We can move from σ₁ to σ₂ by convolving with a filter σ_{F} such that

σ_{F}=\sqrt{(σ₂²−σ₁²)}

If σ₂=2σ₁, then the intrinsic blur of the image obtained by decimating the image with scale σ₂ by 2 in x and y is σ₁. A scale pyramid can be constructed by successively blurring the input image and, every time the scale a doubles, decimating the images to generate a new base image ¼ the size of the previous one, which serves a base image for the following octave. Further Gaussian blurring at sub-octave scaling creates a set of images for each octave that are used for extracting image points.

No image can be perfectly sharp, that is have a scale σ=0, because the optical system is imperfect (even if diffraction limited) and the pixel spatial sampling frequency is not infinite. For example, an input image may be assumed to have an intrinsic blur σᵢₙ=0.5.

Successive Gaussian blurs are used to scan through features at various scales in the image. The starting scale affects the choice of octave blurring filter—that is the filter that needs to be applied to the image to increase the feature size by a factor of two.

For example, to go from σ=0.5 to σ=1.0 requires an additional blur of

σ_{blur}=√(1²−0.5²)=√0.75=0.866.

However, to go from σ=1.0 to σ=2.0 requires an additional blur of

σ_{blur}=√(2²−1²)=√3=1.73.

What this means is that the spatial frequencies being filtered out of the σ=0.5 image are higher than those being filtered out of the σ=1.0 image.

The ideal image I is blurred with a Gaussian filter to give L. L has an intrinsic smallest scale σ:

L(σ)=g(σ)*I

The input image (captured by the sensor) has an assumed intrinsic blur σᵢₙ:

Lᵢₙ=g(σᵢₙ)*I(x,y)

The first and second derivatives of L are written as Lₓ, L_{y}, Lₓₓ, L_{yy}, L_{xy} for compactness:

$${L}_{x} = \frac{\partial L}{\partial x} and {L}_{y} = \frac{\partial L}{\partial y}$$

$${L}_{xx} = \frac{{\partial }^{2} L}{\partial {x}^{2}} , {L}_{yy} = \frac{{\partial }^{2} L}{\partial {y}^{2}} and {L}_{xy} = \frac{{\partial }^{2} L}{\partial x \partial y}$$

It may be desirable to have a detection function that has stability in that interest points should appear at the same position on an object in every frame, as the object moves and rotates, as the lighting changes, regardless of noise. The detection function should have accuracy in that the position of the interest point and the orientation assigned should be accurate enough that the descriptor can be generated accurately with the correct spatial transformation. The descriptor should be accurate enough that, from frame to frame, under appropriate transformations, descriptors of the same interest point neighborhood can be recognized as similar. The detection function should have invariance to transforms in that the interest points and descriptors must be correctly and accurately calculated when the object is translated, rotated in plane or rotated out of plane.

An interest point detection function should return features located in x, y and σ: that is its size (σ) and its position in the image are well defined. Conventional interest point detection functions can detect blob or corner features in an image.

In a digital still or video camera system, pixels are transmitted from the sensor in raster scan data order. Each pixel is only transmitted once. Rolling buffers must be used to hold lines of pixels when processing is required that needs more than one line of the image.

Since a solution is desirable that operates within a single silicon chip, it is imperative to minimize memory size. Therefore it would be desirable to have the extent of convolution filters and the corresponding coefficient kernels be kept small. A single stage algorithm may be preferred. Computation may take place within each frame time, as the interest points are associated with the frame for which they were calculated. Hardware re-use is desirable. Practically, this demands that the calculation is regular across octaves. Therefore, the ratios of scales from filter to filter may be equal.

A second-derivative function such as a Determinant of Hessian (DoH) blob detection function may be used. The Determinant of Hessian (DoH) blob detection function is defined as

$$H = [ \begin{matrix}\frac{{\partial }^{2} L ( x , y , σ )}{\partial {x}^{2}} & \frac{{\partial }^{2} L ( x , y , σ )}{\partial x \partial y} \\ \frac{{\partial }^{2} L ( x , y , σ )}{\partial x \partial y} & \frac{{\partial }^{2} L ( x , y , σ )}{\partial {y}^{2}}\end{matrix} ] ≡ [ \begin{matrix}{L}_{xx} ( x , σ ) & {L}_{xy} ( x , σ ) \\ {L}_{xy} ( x , σ ) & {L}_{yy} ( x , σ )\end{matrix} ]$$

where the ideal “perfectly sharp” input image I is convolved with a Gaussian blurring function to give the blurred image L:

L(σ)=g(σ)*1

The deviation of the Gaussian blur at which the maximal response is found, σ, is a measure of the scale of the features present in the image L. Note that the ideal image is unavailable because the image transmitted from the sensor is already blurred by the optical system. We assume an initial blur of σᵢₙ=0.5 for the input image.

Blobs are found by maxima in the scale normalized determinant of the Hessian:

$$\begin{matrix}{σ}^{4} \vert H \vert = {σ}^{2} \vert \begin{matrix}{L}_{xx} ( x , σ ) & {L}_{xy} ( x , σ ) \\ {L}_{xy} ( x , σ ) & {L}_{yy} ( x , σ )\end{matrix} \vert \\ = {σ}^{4} ( {L}_{xx} ( x , σ ) {L}_{yy} ( x , σ ) - {( {L}_{xy} ( x , σ ) )}^{2} )\end{matrix}$$

The two dimensional Gaussian is separable into independent x & y filters but the derivative filters are not. There is a considerable size advantage in hardware to implementing the Gaussian filter as two similar filters in y and x directions and extracting the derivatives from the results.

L(σ)=gₓ(σ)*g_{y}(σ)*I

The derivatives are derived from the blurred image L(σ):

$${L}_{xx} ( x , y , σ ) = L ( x - 1 , y , σ ) + L ( x + 1 , y , σ ) - 2 L ( x , y , σ )$$

$${L}_{yy} ( x , y , σ ) = L ( x , y - 1 , σ ) + L ( x , y + 1 , σ ) - 2 L ( x , y , σ )$$

$${L}_{xy} ( x , y , σ ) = \frac{1}{4} ( L ( x + 1 , y + 1 , σ ) - L ( x - 1 , y + 1 , σ ) - L ( x + 1 , y - 1 , σ ) + L ( x - 1 , y - 1 , σ ) )$$

As explained above, the starting point for each octave is defined by the octave base image, which has a characteristic blur, σ_{base}. If the value of σ_{base} is sufficiently large, the assumed value of σᵢₙ is not critical. Scaling to the next octave is performed by blurring to double the blur and decimating by 2 in each dimension. Decimation reduces the blur back to σ_{base}. The scale of the Gaussian blurring filter is σ_{g}=σ_{base}√3.

The base blur σ_{base} determines the values of σ for the downscaling Gaussian filter and for each of the Hessian filters. The octave is sub-divided into K intervals, with scales

σₖ=2^{k}/K, k=0. . .K+1

and

σ₀=\sqrt{σ_{base}²+S}

The filter scale σ_{Fk} is given by

σ_{Fk}=\sqrt{σₖ²−σ_{base}²}

S is a constant to give a convenient offset for the Hessian filters, chosen to balance good point stability with filter size. There is an engineering trade off to be made in choosing the value of σ_{base} between filter size and the stability of the interest points. It was observed that if the σ₀ filter is too small the smallest points tended to be less reliably detected. The parameters S=1.25, σ_{base}=1.0 and K=3 give the filters shown in the table:

| | | | Observed response |
|---|---|---|---|
| k | σₖ | σ_{Fk} | peak blob radius |
| 0 | 1.5 | 1.11 | 1.2 |
| 1 | 1.89 | 1.60 | 1.6 |
| 2 | 2.38 | 2.16 | 2.2 |
| 3 | 3.00 | 2.83 | 2.9 |
| 4 | 3.78 | 3.65 | 3.7 |

As the input image is assumed to have an intrinsic blur of σᵢₙ=0.5, an initial blur with σ_{g}=0.866 is applied to the input image to generate the octave 0 base image with a σ_{base}=1.0. However, the hardware implementation does not detect features in octave 0 but starts at octave 1. The input image is conditioned by blurring to σ=2.0, requiring a filter σ_{g}=1.94 and the resulting image decimated to produce the octave 1 base image directly.

Filter kernels Gₓ and G_{y} constructed from a Gaussian kernel G(σ). Gₓ and G_{y} are identical. The reduced precision kernels are generated with:

Gₓ=round(gₓ(σ)×(N−1)), etc

where the number of levels N is used to choose the precision of the kernel elements. Hence

L(σ)≈Gₓ(σ)*G_{y}(σ)*I_{base}

The full expression for the normalized function is:

$${\vert H ( x , σ ) \vert}_{norm} \approx [ {L}_{xx} {L}_{yy} - {L}_{xy}^{2} ] \cdot {[ \frac{{σ}^{2}}{( N - 1 )} ]}^{2}$$

The value of N selected was 32 giving 5 bits of precision for the kernel elements. Five (=K+2) values of σ are used per octave. The 5 1D Gaussian kernels for calculating the Hessians range in size from 7 to 21 elements, a total of 335 bits. The kernels for the downscaled Gaussian blur are stored to higher precision (14 bits) to avoid accumulating rounding errors in successive octaves. They require 448 bits. Stored in ROM or synthesized into gates 783 bits are a minor part of the total logic. Short integer arithmetic also reduces the size of the logic greatly.

Candidate key points are detected as extrema (maxima or minima) in the |H| functions, by comparing each point with its 26 neighbors: 8 in the |H| at one value of σ plus 9 in the previous and next values of σ. Weak features can be rejected with a threshold. More accurate location may be achieved by interpolation between scales and row/column to more precisely locate the extremum. A Taylor expansion (up to the quadratic term) of the |H| function in scale space, H(x,y,σ) may be used:

$$H ( x ) = H + \frac{\partial {H}^{T}}{\partial x} x + \frac{1}{2} {x}^{T} \frac{{\partial }^{2} H}{\partial {x}^{2}} x$$

H is the value of the |H| function at the sample point, and x=(x,y,σ)^{T} is the offset from that point.

The best estimate of the extremum, x, is made by differentiating this expression with respect to x and setting it to zero:

$$\hat{x} = - \frac{{\partial }^{2} {H}^{- 1}}{\partial {x}^{2}} \frac{\partial H}{\partial x}$$

Writing this expression out in full:

$$( \begin{matrix}\hat{x} \\ \hat{y} \\ \hat{σ}\end{matrix} ) = - {( \begin{matrix}\frac{{\partial }^{2} H}{\partial {x}^{2}} & \frac{{\partial }^{2} H}{\partial x \partial y} & \frac{{\partial }^{2} H}{\partial x \partial σ} \\ \frac{{\partial }^{2} H}{\partial y \partial x} & \frac{{\partial }^{2} H}{\partial {y}^{2}} & \frac{{\partial }^{2} H}{\partial y \partial σ} \\ \frac{{\partial }^{2} H}{\partial x \partial σ} & \frac{{\partial }^{2} H}{\partial y \partial σ} & \frac{{\partial }^{2} H}{\partial {σ}^{2}}\end{matrix} )}^{- 1} ( \begin{matrix}\frac{\partial H}{\partial x} \\ \frac{\partial H}{\partial y} \\ \frac{\partial H}{\partial σ}\end{matrix} )$$

The derivatives in the above equation are approximated from the calculated Hessians H_{O,s} and its neighboring Hessians H_{O,s-1} and H_{O,s+1}. The result is a 3×3 matrix for the second derivative that needs to be inverted. (Note that this matrix is symmetrical.)

A principal direction of an interest point is assigned by building a weighted histogram of the gradients in the surrounding region and finding its modal value. The weighted histogram of gradients is calculated from the octave base image for each octave. The gradients calculated for this stage will also be useful in the calculation of the descriptors. The descriptors are extracted using the gradient histograms that are calculated from the octave base image for each octave.

The procedure for orientation assignment involves calculating a gradient histogram of intensity gradients in the blurred image L_{O,s} surrounding an interest point. In SIFT the histogram had 36 bins, each 10° wide. We use 32 bins, each 11.25° wide. The local gradient magnitude and direction are calculated at each image sample location, as follows:

$$m ( x , y ) = \sqrt{{( L ( x + 1 , y ) - L ( x - 1 , y ) )}^{2} + {( L ( x , y + 1 ) - L ( x , y - 1 ) )}^{2}}$$

$$θ ( x , y ) = \{ \begin{matrix}\begin{matrix}{tan}^{- 1} & ( \frac{( L ( x , y + 1 ) - L ( x , y - 1 ) )}{( L ( x + 1 , y ) - L ( x - 1 , y ) )} )\end{matrix} & \begin{matrix}if L ( x , y - 1 ) \leq \\ L ( x , y + 1 )\end{matrix} \\ \begin{matrix}{tan}^{- 1} & ( \frac{( L ( x , y + 1 ) - L ( x , y - 1 ) )}{( L ( x + 1 , y ) - L ( x - 1 , y ) )} ) + π\end{matrix} & \begin{matrix}if L ( x , y - 1 ) > \\ L ( x , y + 1 )\end{matrix}\end{matrix}$$

The gradient magnitudes m(x,y) at each location are then multiplied by a Gaussian envelope, with σ=1.5×σ_{mid} (where σ_{mid} is the scale of the Hessian filter nearest to the interest point scale).

In practice the Gaussian envelope width is set by scaling the distance of the gradient from the interest point using σ_{mid}:

$$d = \frac{2.4 \sqrt{Δ {c}^{2} + Δ {r}^{2}}}{{σ}_{mid}}$$

The distance d is used to index into a short table of integer values for a 1 dimensional Gaussian filter with σ=3.36. The integer part of d, [d], is used to index into the table. The fractional part, (d-[d]), is used to interpolate to give a more accurate value for the weight:

di=[d]

df=d−di

W=G336[di]+(G336[di+1]−G336[di])×df

The weighted gradient magnitude W×m is added to the correct direction bin B_{θ}(t).

Once the histogram has been constructed, its modal value is found. A more accurate value for the peak of the histogram is extracted by quadratic interpolation. If B_{θ}(t) is the bin with the modal value, a more accurate angle for the orientation angle θₒᵣᵢ is given by:

$${θ}_{ori} = \frac{{B}_{θ} ( t - 1 ) - {B}_{θ} ( t + 1 )}{2 ( {B}_{θ} ( t - 1 ) + {B}_{θ} ( t + 1 ) - 2 {B}_{θ} ( t ) )}$$

θₒᵣᵢ is assigned to the interest point as its orientation. In the case where the peak is not unique, and the second peak is 80% or more the population of the largest peak, a new interest point record is created at the same position in the same way.

Descriptors may be constructed around each interest point, as shown in step 22 of FIG. 2. A descriptor describes the image structure around an interest point. An object may have tens, hundreds, or thousands of descriptors. As an object is scaled or rotated between images, the object's descriptors are also scaled and rotated.

Descriptors may need to be formulated and constructed in such as way as to allow for good performance in a hardware implementation where there may be limited processing or memory resources. Conventional descriptor tend to be very large and to contain much redundant data.

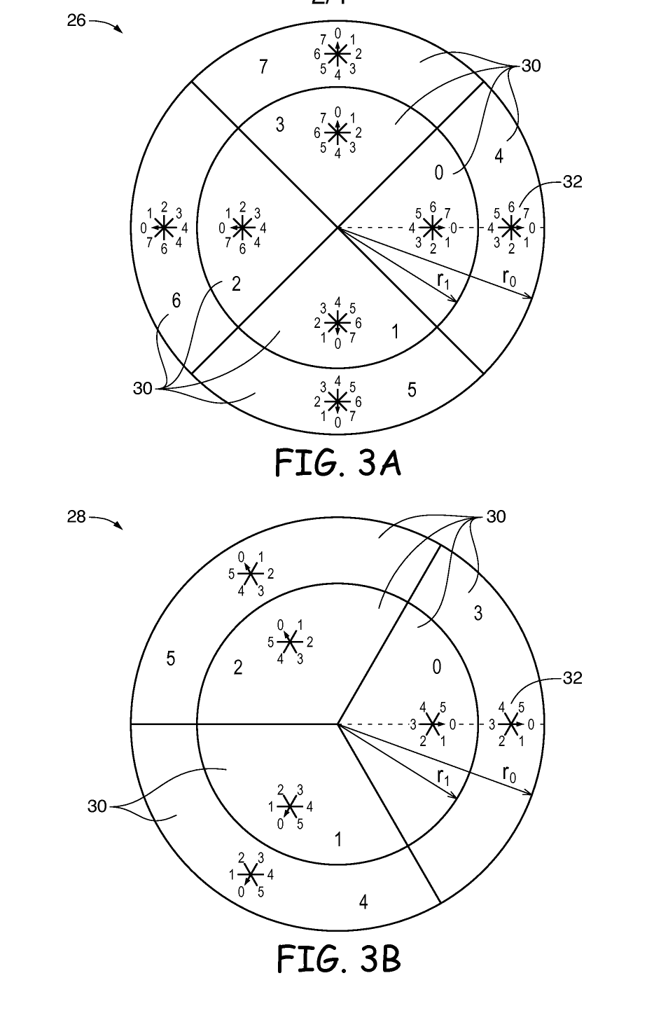

A family of rotating histogram of gradient descriptors may be used. These rotating histogram of gradient descriptors may be known as polar histogram of gradient (PHOG) descriptors. The descriptors may have a circular spatial layout having one or two rings of cells. Each ring may be radially divided into cells. Illustrative descriptors are shown in FIGS. 3A and 3B. Descriptor 26 of FIG. 3A has two rings, each ring having four cells 30. Cells 30 may of descriptor 26 may be numbered from 0 to 7. Descriptor 28 of FIG. 3B has two rings, each ring having three cells 30. Cells 30 of descriptor 28 may be numbered from 0 to 6. If a descriptor has two rings, each ring may be of equal area. A two-ringed descriptor may have outer and inner radii r₀ and r₁, respectively, as shown in FIGS. 3A and 3B. Outside radius r₀ may be related to inside radius r₁ by r₀=rᵢ/√2.

A descriptor such as descriptor 26 or 28 is oriented to align with the orientation of the interest point. For example, cell number 0 of a descriptor may have the same orientation as the interest point of that descriptor. The rotation positions of a descriptor may be limited to a discrete number of positions, such as 256 positions. Other suitable numbers of rotation positions may also be used, if desired. Each cell 30 of a descriptor may have a cell orientation that points outwards from the interest point at the center of the descriptor. The orientation of each cell 30 is marked by axes such as axes 32 of FIGS. 3A and 3B. Having rotating descriptors differs from conventional methods in which descriptors are stationary and an image is rotated.

Rotation is achieved by selecting which 4 (nearest) cells each gradient will contribute to and applying smoothly varying weights dependent on the angular distance from the centre of the cells. The angular weight has a simple linear relationship to the angle between the cell centre and the position.

The size of a descriptor must be matched to the scale of its associated interest point. In conventional software implementations, continuous scale adjustment of the descriptor is done by transforming the co-ordinates of every gradient with respect to the interest point. Such an approach is difficult in hardware.

An approach is taken that selects a number of fixed sized descriptor templates that cover the range of interest point scales: a single octave. The closest template to the scale of the interest point is chosen for constructing the descriptor. The “scale resolution” is determined by the number of templates chosen in each octave. The scale resolution may be a sub-octave scale resolution, for example, one per octave, two per octave, three per octave, five per octave or fewer, ten per octave or fewer. The number of templates may or may not match the number of Hessian filter scales used to calculate the points. The templates are embodied as a set of kernels of weights matching each scale, known as “radial weights”. The radial weight has a Gaussian profile with a spread proportional to the size of the descriptor.

The size of the descriptor patch (P) and the number of descriptor scales per octave (Z) determine the sizes of the rings of weights shown in

$${r}_{o , n} = \frac{P}{{2}^{1 + \frac{n}{Z}}} , n = 0 … ( Z - 1 )$$

The parameters of the Gaussian profiles are chosen to satisfy the following criteria:
At the boundary between the inner and outer cells both distributions will have half their full height.
The maximum of the inner cells will lie at

r_{μ,i,n}=3σ_{i,n.}
The maximum of the outer cells will lie at

r_{μ,o,n}=r_{o,n}−2σ_{o,n.}

resulting in:

r_{μ,o,n}=0.51 r_{o,n}, σ_{i,n}=0.17 r_{o,n}

r_{μ,o,n}=0.82 r_{o,n}, σ_{i,n}=0.092 r_{o,n}

To calculate the histograms for each cell, first all the image gradients in the patch are calculated as magnitude and direction (m,θ). Note that these are the same values used for calculation of orientation assignment, which are calculated from the octave base image for each octave. Each gradient magnitude contributes to two of the cells in the ring, weighted by the product of two weights for the angular and radial distance from the centre of the cell. The edges of the cells are soft and the cells overlap and blend into one another. This makes the descriptor less sensitive to small uncertainties in its position. Within each cell, the weighted gradient magnitude, m, is shared proportionally between the two nearest direction bins, according to the gradient direction, θ. In each cell, direction bin 0 corresponds to the direction from the interest point to the centre of the cell. Once the descriptor vector is calculated each cell is L1 normalized and resealed to 8-bit positive integers.

Several parameters of the descriptor may be varied:
P: Patch size for calculating the descriptor.
Z: the number of descriptor scales/sizes
N: no of rings
C: no of cells in the ring
H: no of directional bins in each cell
B: no of bits stored for each element of vector
   P does not affect the size of the descriptor vector. The number of elements in the vector is N*C*H and the number of bits is N*C*H*B.

The choice of these parameters may be determined by a combination of the descriptor's performance at matching from one image to another, the size of the vector and by the adaptability of the configuration to hardware implementation.

A compression scheme designed to reduce the length of the descriptor coefficients from 8 to 4 bits while minimizing the loss of entropy has been devised. By means of a simple look-up table, the length of the descriptor can be halved. This may be a switchable feature in the implemented hardware.

As shown in step 24 of FIG. 2, an object may be tracked through the multiple images by matching descriptors between the images. A pair-wise matching algorithm may be used that counts the number of matching descriptors between images. A match (or hit) may be determined by calculating the L1 distance between each pair of descriptor vectors and finding the minimum, provided it is less than the next smallest by a discrimination factor constant, which may be set at value such as 0.8. Other suitable matching algorithms may also be used.

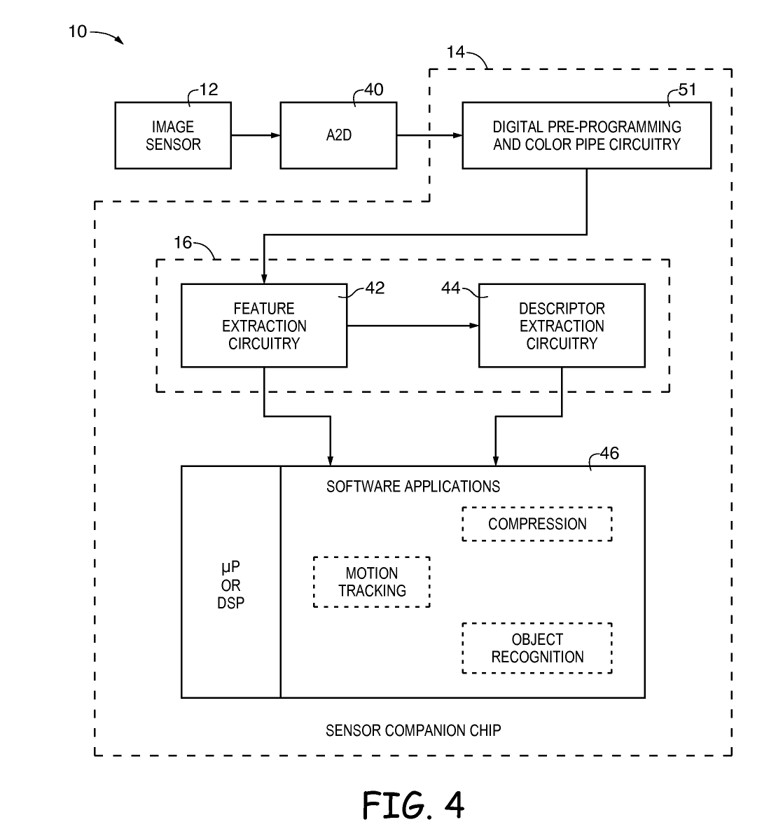

FIG. 4 shows an illustrative implementation of imaging device 10. Imaging device 10 of FIG. 4 may have image sensor 12 and image processor 14, as in the example of FIG. 1. Output from image sensor 12 may be provided to analog-to-digital converter 40. Output from analog-to-digital converter 40 may be provided to image processor 14. Image processor 14 may be implemented on a sensor companion chip. Image processor 14 may have digital pre-processing and color pipe circuitry 51 that receives images from analog-to-digital converter 40.

Interest point and description circuitry 16 may include feature extraction circuitry 42 and descriptor extraction circuitry 44. Feature extraction circuitry 42 may receive output from digital pre-processing and color pipe circuitry 51. Descriptor extraction circuitry 44 may receive output from feature extraction circuitry 42. Microprocessor or digital signal processor (DSP) 46 may receive output from interest point and description circuitry 16.

In the example of FIG. 4, a huge computational load has been lifted from downstream processing because interest point data is presented to the microprocessor (or DSP) as the image frame is transmitted from the sensor. The quantity of data read by the microprocessor is far less and the computational effort to generate the features and descriptors has been moved out of the microprocessor altogether, freeing it to perform less regular tasks (for example, motion tracking, descriptor compression or object recognition).

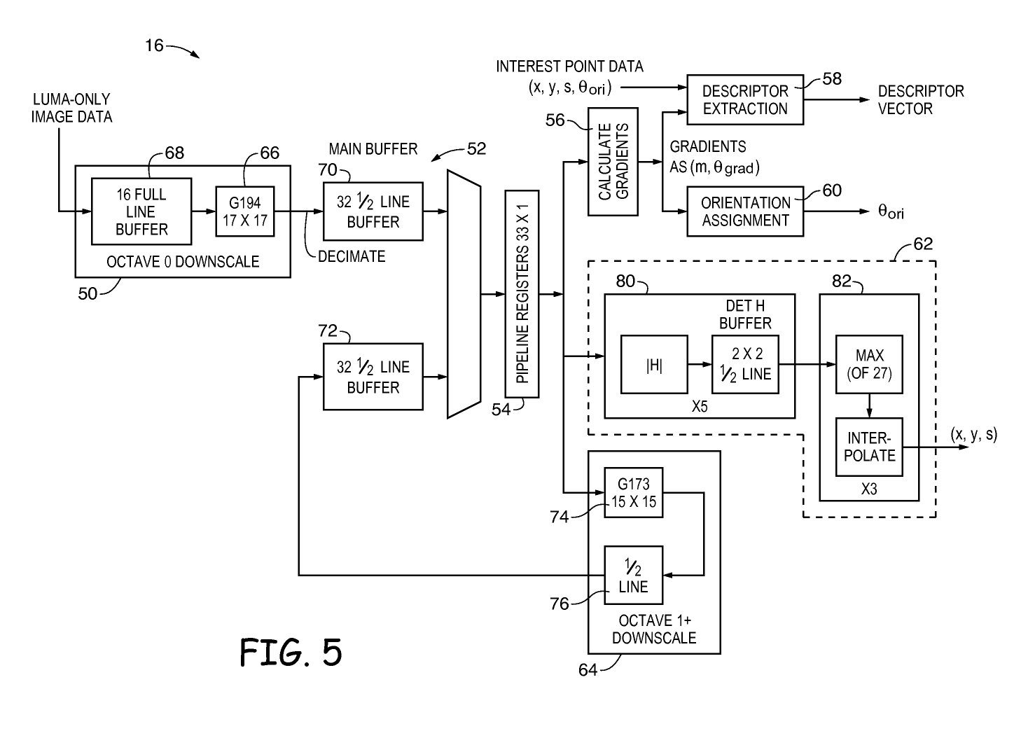

An illustrative hardware implementation for interest point and description circuitry 16 of FIGS. 1 and 4 is shown in FIG. 5. In the implementation of FIG. 5, interest points and descriptors are computed as images are received from an image sensor through a pipeline with minimal buffering. Entire images do not need to be stored by interest point and description circuitry 16. Interest point and description circuitry 16 may need to store only a portion of one image at any given time. For example, 23 lines may be stored at any time for interest point extraction. For descriptor calculation, 33 lines may be stored. These numbers of lines are merely examples. Any suitable number of lines may be held by interest point and description circuitry 16.

Some key features of the implementation of FIG. 5 include: Downscaling the 1st octave without feature extraction frees time for subsequent processing in later octaves. There are 5 fixed Gaussian filter kernels for calculating the Hessian at each σ, operating on a 21×21 image patch. Each coefficient is a 5 bit signed integer. The equalization factors were pre-calculated with the filter. The results of the filters are combined to give |H|. Local maxima in |H| are detected to find points. Weak points are weeded out by applying a threshold. Accurate location in (x,y,s) is determined by interpolation. A downscale by Gaussian blur and decimation is repeated on each octave reducing the size of the data for each time by a factor of 4. Gradients are calculated for orientation assignment and for descriptor construction using a larger (32×32) patch of image data. By choosing appropriate parameters for the descriptor configuration, the many possible angular weight kernels can be reduced to simple reflections and π/2 rotations of a few starting kernels. For example 32 rotational positions of a 6 cell descriptor can be achieved with just 5 starting kernels.

Luma-only image data may be presented to Octave 0 Downscale circuitry 50. Assuming that a pixel clock is used to drive data through the feature detector, octave 0 buffer 68 is read and written on every cycle. Therefore, dual port RAMs or SAMs may be needed. Filter 66 of circuitry 50 may be a 17×17 integer filter. The arithmetic of the Gaussian filter may be performed with separate row and column Gaussian filters, which saves arithmetic. The vertical Gaussian may be performed first, so buffer 68 holds pixels not partial results. All the Gaussian filters may be built to the same pattern, with differences in size and memory type. Octave 0 may be also known the first octave.

The output from filter 66 of Octave 0 Downscale circuitry 50 may be decimated on writing into main buffer 52 (i.e. only every other result is used and every other output line). Main buffer 52 may have octave 1 buffer (OB1) 70, sourced from the downscaled data from octave 0, and the other octaves buffer (OBO) 72, sourced from the delayed, downscaled data from most recent pass through the main buffer 52 itself. Because data is valid only on every other cycle, reads and writes can be made separate, so single port RAMs may be used which saves space. The timing of the OBO 72 is exactly the same as OB1 70, but it is cycled on the Other Octaves lines, between the Octave 1 lines. The data in the main buffer 52 are pixels. All the subsequent Gaussian filters for the downscale and the Hessians are implemented separably, vertical filter first to the same pattern as the octave 0 downscale. By calculating the vertical filter before the horizontal, the buffer can hold pixels rather than part filtered values.

To save memory, the hardware will perform only a downscale on the first octave with no feature detection so only buffering for the Gaussian blur filter is needed. This also has an important timing benefit, because only half the lines are needed to process the first octave feature detect, freeing every other line time for processing subsequent octaves. Therefore the pipeline registers can be shared between all the octaves and no hardware limitation need be put on the number of octaves processed.

The pipeline registers 54 in the main buffer 52 hold data for all subsequent calculations: that Gaussian filter for the octave downscale, the Gaussian filters for the Hessian calculation and the gradient calculations for orientation assignment and descriptor construction. Main buffer 52 may have an input coupled to the Octave 0 Downscale circuitry 50, an input coupled to Octave 1+Downscale circuitry 64, an output coupled to gradient calculating circuitry 56, an output coupled to the interest point detection circuitry 62, and an output coupled to Octave 1+Downscale circuitry 64.

Octave 1+Downscale circuitry 64 may receive data from main buffer 52. Octave 1+Downscale circuitry 64 may perform octave downscaling functions and output image data to back to the input of main buffer 52. Octave 1+Downscale circuitry 64 and main buffer 52 may be used for octaves one and greater. Circuitry 64 may have filter circuitry 74 having a Gaussian filter that is implemented separably, vertical filter first. The filters have σ=1.73, so are only 15 taps long. The result is passed into a delay buffer 76 (½ line in length)—held until the line is processed later. The downscaled line from octave 1 is ¼ line in length, from octave 2 ⅛ line in length and so on. Octave 1 may also be known as the second octave (octave 0 is the first octave). Accordingly, octaves 1 and greater may be known as the second and greater octaves.

Interest point detection circuitry 62 may receive output from main buffer 52. The Hessian is calculated at circuitry 80 for 5 different scales. Each Hessian calculation consists of 3 separable Gaussian filters and the calculation of the second derivatives and the determinant of the Hessian matrix at each pixel from the filter results. Each filter kernel is a vector of 5 bit positive integers. The filter sizes are different for each value of σ.

Maxima detection and interpolation circuitry 82 looks for points that are maximal in |H| in the (x,y,σ) neighborhood of 27 pixels. Therefore results are held from previous lines calculated for comparison. Two line buffers support the detection of maxima in the Hessian blob response. These are twice a half line in length to allow for all octaves, hence 4 half lines per Hessian block, that is 20 half lines in all. Comparisons have to be made with the three middle scales at the centre of the 27 pixel box: i.e. three times.

There are 5 sets of Hessian calculation arithmetic, each using filters with a different scale or variance. These are used to span a range of scales slightly larger than a whole octave. Maxima are detected in the three inner Hessians and interpolation used to position the interest point more accurately in position and scale. Gradients are calculated for use in the orientation assignment and descriptor extraction blocks, both of which are fairly complex arithmetic blocks that build histograms.

Output from main buffer 52 may be provided to gradient calculating circuitry 56. Gradient calculating circuitry 56 may perform gradient histogram calculations on octave base images received from main buffer 52. Descriptor extraction circuitry 58 may receive interest point data. Descriptor extraction circuitry 58 may receive gradient data from gradient calculating circuitry 56. Descriptor extraction circuitry 58 may extract descriptors using gradient histograms that are calculated from octave base images.

Orientation assignment circuitry 60 may receive gradient data from gradient calculating circuitry 56. Orientation assignment circuitry 60 may assign orientations to interest points using gradient histograms that are calculated from octave base images.

Various embodiments have been described illustrating methods and apparatus for a hardware implementation of interest point and descriptor circuitry.

Interest point and descriptor circuitry may be provided on an imaging device such as a digital camera. Interest point and descriptor circuitry may be provided on a cellular telephone having a digital camera. Interest points and descriptors may be calculated at frame rate, during frame output from an image sensor. Rotating gradient-histogram descriptors may be used that are circular and have one or two rings of cells. A fixed set of rotations of the descriptor are used. Descriptors may have 256 possible rotational positions.

A base image for an octave is the source for all of the gradients for the descriptor in any size. Fixed sub-octave scales are used for descriptor templates and the template having a scale closest to the scale of the interest point is chosen for constructing the descriptor. The overall weighting for each gradient into each bin is a product of an angular component, a radial component, and a directional weighting component. The radial weights have a Gaussian profile.

The foregoing is merely illustrative of the principles of this invention which can be practiced in other embodiments.

What is claimed is:

1. An electronic device, comprising:
an image sensor that captures images; and
interest point and descriptor circuitry, comprising:
first circuitry for downscaling the images by a first octave; and
second circuitry for downscaling the images by a second octave, wherein the second circuitry is reused for downscaling the images by at least a third octave, and wherein the interest point and descriptor circuitry is configured to extract interest points and descriptors for the images as the images are received from the image sensor.

2. The electronic device defined in claim 1, wherein the interest point and descriptor circuitry further comprises:
gradient calculating circuitry that is configured to calculate gradient histograms from an octave base image for each of the first, second, third octaves; and
descriptor extraction circuitry that receives the gradient histograms from the gradient calculating circuitry and that is configured to extract the descriptors for the images, wherein the descriptors comprise circular gradient-histogram descriptors having discrete rotational positions and discrete scaling.

3. The electronic device defined in claim 2, wherein the interest point and descriptor circuitry further comprises interest point detection circuitry that is configured to extract the interest points for the images using a second-derivative blob detection function.

4. The electronic device defined in claim 3, wherein the circular gradient-histogram descriptors each have at least two rings of equal area.

5. The electronic device defined in claim 4, wherein the descriptor extraction circuitry is configured to extract the descriptors using an angular weighting component, a radial weighting component, and a directional weighting component.

6. The electronic device defined in claim 5, wherein the interest point and descriptor circuitry further comprises orientation assignment circuitry that receives the gradient histograms from the gradient calculating circuitry and that is configured to determine orientations for the interest points.

7. The electronic device defined in claim 6, wherein the interest point and descriptor circuitry further comprises a buffer comprising:
a first input coupled to the first circuitry for downscaling the images;
a second input coupled to the second circuitry downscaling the images;
a first output coupled to the gradient calculating circuitry;
a second output coupled to the interest point detection circuitry; and
a third output coupled to the second circuitry for downscaling the images.

8. A method for extracting interest points and descriptors from images on an image processing integrated circuit, comprising:
receiving, at the image processing integrated circuit, a plurality of images of an object, wherein the plurality of images are received at a frame rate;
extracting interest points on the object for the plurality of images, wherein the extracting of interesting points is performed by the image processing integrated circuit at frame rate;
extracting descriptors for the interest points, wherein the extracting of descriptors is performed by the image processing integrated circuit at frame rate, wherein the descriptors comprise rotating gradient-histogram descriptors having discrete rotational positions and discrete scaling.

9. The method defined in claim 8, wherein extracting interest points for the interest points comprises:
scaling each image using Gaussian functions to produce a plurality of scaled images for each image; and
applying a second derivative feature detection function to each of the plurality of scaled images, wherein the plurality of scaled images have sub-octave scaling.

10. The method defined in claim 9, wherein extracting descriptors for the interest points comprises:
extracting descriptors using gradient histograms calculated from an octave base image for each octave; and
selecting a scale for each descriptor from a set of descriptor templates having a fixed sub-octave scale resolution.

11. The method defined in claim 10, wherein extracting descriptors for the interest points comprises calculating gradient histograms using angular weights and radial weights and wherein the radial weights have Gaussian profiles.

12. The method defined in claim 10, wherein extracting descriptors for the interest points further comprises calculating gradient histograms using an angular weighting component, a radial weighting component, and a directional weighting component.

13. The method defined in claim 10, wherein the descriptors comprise one or more rings, wherein each ring is radially divided into cells, and wherein the image processing integrated circuit stores only a portion of each image at a time.

14. Circuitry on an integrated circuit, comprising:
feature extraction circuitry that extracts interest points from each of a plurality of images; and
descriptor extraction circuitry that is configured to construct descriptors associated with each of the interest points, wherein the descriptors comprise rotating gradient-histogram descriptors having discrete rotational positions.

15. The circuitry defined in claim 14, wherein the descriptors each comprise:
an inner ring of cells having an inner area; and
an outer ring of cells having an outer area, wherein the outer area is the same as the inner area.

16. The circuitry defined in claim 15, wherein each descriptor has a size that is selected from a set of descriptor templates having fixed sub-octave scales.

17. The circuitry defined in claim 16, wherein the descriptors are constructed using gradient histograms calculated from an octave base image for each octave and wherein gradient weighting for the gradient histograms is performed for each descriptor using an angular component, a radial component, and a directional weighting component.

18. The circuitry defined in claim 17, wherein each descriptor template has an associated radial weight having a Gaussian profile.

19. The circuitry defined in claim 14, wherein the feature extraction circuitry is configured to apply successive Gaussian blurs to each of the plurality of images to produce a plurality of blurred images, wherein the plurality of blurred images have a scale that is measured in octaves, and wherein no interest points are extracted from blurred images in a first octave above a base scale.

20. The circuitry defined in claim 19, wherein the feature extraction circuitry is configured to apply a feature detection function to the blurred images and wherein the feature detection function comprises a second-derivative function.
